(19) United States
(12) Patent Application Publication
(10) Pub. No.: US 2008/0320124 A1
(43) Pub. Date: Dec. 25, 2008

(54) DATA-ASSISTED CONTENT PROGRAMMING

(75) Inventors: Min Woo Lee, New York, NY (US); Tony San Lee, Palo Alto, CA (US); Nicolas Remy, Palo Alto, CA (US)

Correspondence Address: FIALA & WEAVER, P.L.L.C.;C/O INTELLEVATE, P.O. BOX 52050, MINNEAPOLIS, MN, 55402, US

(73) Assignee: YAHOO! INC., Sunnyvale, CA (US)

(21) Appl. No.: 11/766,913

(22) Filed: Jun. 22, 2007

(51) Int. Cl. G06F 15/173; G06F 17/30

(52) U.S. Cl. 709/224; 707/102; 707/E17.116

(57) ABSTRACT

Methods, systems, and apparatuses for data-assisted content programming are described. Link access data for a website is collected, such as numbers and times of views and clicks for links of the website, and link generated revenue information. The link access data is optionally stored. A link performance measure is generated for a link based on the link access data. An indication of the calculated link performance measure for the link is graphically displayed in a content scheduler. The indication may be based on an actual click through rate for the link, on an average click through rate for links in a module in which the link resides, link user engagement information, revenue generated by the link, or on other link access data. The content scheduler may display a website content schedule timeline or a webpage preview that includes the graphical indication.

### BACKGROUND OF THE INVENTION

1. Field of the Invention

The present invention relates to the scheduling of Internet content in websites.

2. Background Art

“Hyperlinks,” which may also be referred to as “links,” are navigational elements in documents that when selected by a user, automatically bring the referred information to the user. Hyperlinks are a fundamental part of the World Wide Web (the “Web”), being widely used in hypertext markup language (HTML) documents, which are represented on the Web as “webpages.”

Content scheduling tools are used by content programmers to create webpages that include content for viewing on the Web. A webpage may be segmented into modules by a content programmer. Using the content scheduler, the content programmer schedules the display of content in each module. Such content may includes picture images, text, audio, video, etc. Hyperlinks may be associated with the scheduled content to provide users with access to additional content. After the webpage is programmed, it is made accessible on the Web. Users can access the webpage on the Web, and are enabled to select links present in the webpage to access the additional content.

However, once a webpage is made accessible, a content programmer cannot easily assess its performance. It may be useful for a content programmer to know how a webpage and related content is performing. Such information would be useful to the programmer in improving present content, and in programming future content for users. Such performance information is not currently available to content programmers in a convenient fashion.

Thus, what is desired are improved ways of providing webpage performance information to content programmers to assist them in providing useful present and future content.

### BRIEF SUMMARY OF THE INVENTION

Methods, systems, and apparatuses for data-assisted content programming are described. Performance information regarding links in websites is provided to content programmers directly in a content scheduling tool. The provided performance information enables content programmers that are programming content to assess a performance of past scheduled content, and to enable the programmers to provide an improved future content schedule.

In a first example aspect, link access data for a website is collected. The collected link access data is optionally stored. A link performance measure is generated for one or more of the links based on the link access data. An indication of the link performance measure for a link is graphically displayed in a content scheduler.

A variety of types of link access data for a website may be collected, such as numbers and times of views and clicks of links, revenue generated by clicking a link, and further types of link access related information. Furthermore, a variety of types of link performance measures may be generated, such as a click through rate (CTR) for a link, a user engagement measure (e.g., a number of subsequent webpage views by a user resulting from clicking a link), a total amount of revenue generated by a link, and further types of link performance related measures.

In an example aspect, the content scheduler may display the graphical indication of the link performance measure in a content schedule timeline. In another example aspect, the content scheduler may display the graphical indication on a preview webpage. Graphical performance indications may be overlaid on links of a webpage. Such an overlay of graphical indicators on a webpage may be referred to as a link “heat-map.” The graphical indications may indicate performance by color, by grayscale, by graphical shape, graphical content, and/or by other graphical technique.

In another example aspect, a data-assisted content programming system is provided. The system includes a link access data collector, a link performance measure generator, and a display engine. The link access data collector is configured to collect link access data for a website. The link performance measure generator is configured to generate a link performance measure based on the link access data. The display engine is configured to generate a graphical indication of the link performance measure for the link for display by a content scheduler.

In aspects, the link performance measure generator may be configured to generate various types of link performance measures. For example, the link performance measure generator may be a click through rate (CTR) calculator configured to calculate a click through rate for a link based on the link access data. In another example, the link performance measure generator may be a user engagement information calculator. In another example, the link performance measure generator may be a link revenue calculator.

In an example aspect, the link access data collector may include a link access tracker and a link data extractor. The link access data collector is configured to collect data related to accesses of links. The link data extractor is configured to extract link access data relating to one or more designated time periods or other predetermined criteria.

For example, the link access tracker may be configured to track views of links on a webpage of the website and to track clicks of the links. The link data extractor may be configured to extract link access data, such as view counts and click counts that occurred during a specified time period for the links from the tracked information. The link data extractor may also be configured to extract a number of webpage views by a user resulting from a click of a link, or other type of user engagement related information.

In another example, the link access tracker may be configured to track revenue generated by clicks of links, and the link data extractor may be configured to extract generated revenue totals for the links during specific time periods and/or according to other criteria.

In an example aspect, the data-assisted content programming system further includes a database configured to store the extracted link access data.

In an example aspect, the data-assisted content programming system further includes a web service that includes the link performance measure generator. The web service is configured to receive a request for a link performance measure, such as CTR, link revenue, user engagement, etc. The web service is configured to access the database for stored link access data corresponding to the link performance measure request, and to make any necessary calculations. For example, the link performance measure generator may include a CTR calculator, a user engagement information calculator, and/or a link revenue calculator.

In a still further example aspect, the content scheduler displays a webpage that includes the link with the graphical indication overlaid on the link.

In an alternative example aspect, the content schedule displays a content schedule timeline with the graphical indication, which indicates an average CTR, link revenue, user engagement, and/or other link performance measure overlaid on the content schedule timeline for a module that includes the link.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of an example content programming system.

FIG. 2 shows an example display generated by a content scheduler.

FIG. 3A shows a block diagram of a content programming system, according to an embodiment of the present invention.

FIGS. 3B-3D show block diagrams of example embodiments for a link performance measure generator, according to embodiments of the present invention.

FIG. 4 shows a flowchart providing example steps for operation of a content programming system, according to an example embodiment of the present invention.

FIG. 5 shows a block diagram of a content programming system, which is an example of the content programming system shown in FIG. 3A, according to embodiment of the present invention.

FIG. 6 shows a flowchart providing example steps for tracking link accesses, according to an embodiment of the present invention.

FIG. 7 shows an example block diagram representation of a webpage.

FIG. 8 shows a flowchart providing example steps for communications between a display engine and a web service, according to an embodiment of the present invention.

FIG. 9 shows a flowchart providing example steps for operation of a web service, according to an embodiment of the present invention.

FIG. 10 shows a block diagram of a web service, according to an example embodiment of the present invention.

FIG. 11 shows a block diagram of a content programming system, according to an embodiment of the present invention.

FIGS. 12 and 13 show example displays generated by content schedulers that includes graphical link performance information, according to embodiments of the present invention.

FIG. 14 shows an example webpage displayed by a content scheduler with graphical link performance information, according to an embodiment of the present invention.

FIG. 15 shows an example webpage.

FIG. 16 shows the webpage of FIG. 15 displayed with graphical link performance information, otherwise known as a link “heat map,” according to an embodiment of the present invention.

FIG. 17 is a block diagram of a computer system in which embodiments of the present invention may be implemented.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### EXAMPLE EMBODIMENTS

The example embodiments described herein are provided for illustrative purposes, and are not limiting. Further structural and operational embodiments, including modifications/alterations, will become apparent to persons skilled in the relevant art(s) from the teachings herein.

Content scheduling tools are used by content programmers to create webpages that include content for viewing on the Web. For example, FIG. 1 shows a block diagram of a content programming system 100. In FIG. 1, system 100 includes a website 102 and a content scheduler 104. Website 102 includes one or more webpages that display content organized by one or more content programmers using content scheduler 104. Content scheduler 104 is typically a software program. Content scheduler 104 is used to a content programmer to schedule the content of website 102. Content scheduler 104 may load one or more webpages of website 102 for scheduling/editing. Content scheduler 104 has a user interface that enables a programmer to schedule content in the loaded webpage(s) of website 102, such as picture image files, text, audio files, video files, etc.

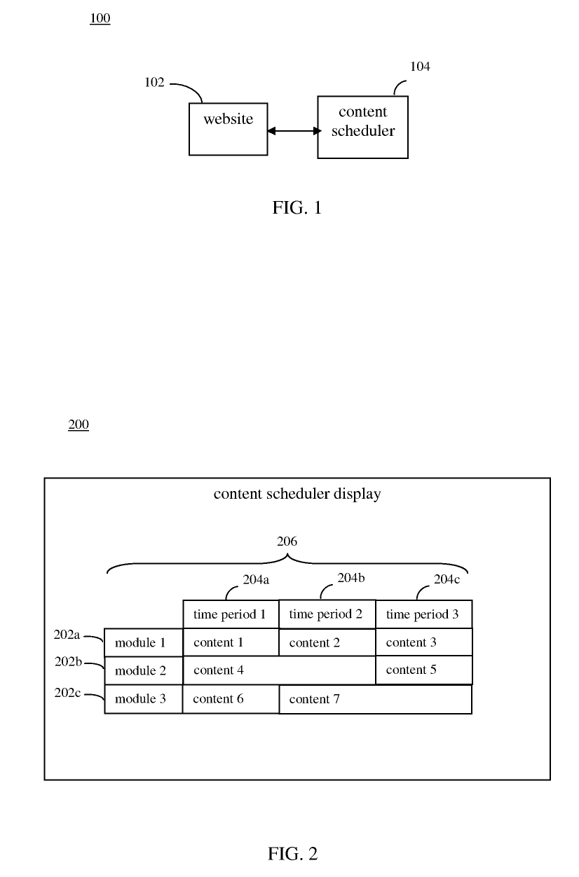

FIG. 2 shows an example display 200 generated by content scheduler 104. Display 200 enables a content programmer to view and schedule content included in a selected webpage of website 102. In the example of FIG. 2, display 200 enables the content programmer to view scheduled content on a module-by-module basis. As shown in FIG. 2, the selected webpage includes three modules (modules 1-3). A module is a section of a webpage that typically, although not necessarily, includes interrelated content. For example, a module may include one or more of any combination of image files, text, audio files, video files, etc., including one or more links associated with any of the same. Display 200 enables the content programmer to view such content on a timeline for each of the three modules 1-3.

As shown in FIG. 2, display 200 includes a content schedule timeline table 206. Table 206 displays scheduled module content along a timeline. In the example of FIG. 2, table 206 includes three rows 202a, 202b, and 202c, and three columns 204a, 204b, and 204c. Each of rows 202a-202c corresponds to one of modules 1-3. Each of columns 204a-204c corresponds to a respective time period (time periods 1-3). Time periods 1-3 can be any desired length of time, such as 15 minutes, 30 minutes, one hour, four hours, etc., as desired for a particular application. Any number of time periods and modules may be present in table 206, as desired for a particular application.

As shown in the example of FIG. 2 for table 206, a first content (content 1) is in row 202a and column 204a of table 206, and thus is scheduled for time period 1 in module 1. A second content (content 2) is in row 202a and column 204b, and thus is scheduled for time period 2 in module 1. A third content (content 3) is in row 202a and column 204c, and thus is scheduled for time period 3 in module 1. A fourth content (content 4) is in row 202b and columns 204a and 204b, and thus is scheduled for time periods 1 and 2 in module 2. A fifth content (content 5) is in row 202b and column 204c, and thus is scheduled for time period 3 in module 2. A sixth content (content 6) is in row 202c and column 204a, and thus is scheduled for time period 1 in module 3. A seventh content (content 7) is in row 202c and columns 204b and 204c, and thus is scheduled for time periods 2 and 3 in module 3.

Using content scheduler 104, a content programmer can alter the content to be displayed on a webpage, and the timing of display of the content, by changing the schedule in table 206. Typically, using content scheduler 104, a content programmer can invoke a preview webpage to view a webpage as currently configured, including viewing the links present in the webpage. However, once the webpage is made accessible on the Web for viewing by users, it is difficult for the content programmers to ascertain the performance of links provided in webpage. For example, it may be difficult for the content programmer to know how often displayed links are accessed by users. Such information is not accessible in a content scheduler, because conventional content schedulers are forward looking. In other words, conventional content schedulers enable a user to program future content, but provide no information on the performance of prior content. It would be beneficial for content programmers to be able to view link performance data in content scheduler 104. This would enable content programmers to more quickly and accurately optimize content provided in webpages.

Embodiments of the present invention are described in detail below that enable content programmers to view link performance information in a content scheduler. In an embodiment, the link performance information is provided graphically in a content scheduling tool, to enable content programmers to more quickly and accurately optimize webpage content.

### EXAMPLE EMBODIMENTS

The example embodiments described herein are provided for illustrative purposes, and are not limiting. The examples described herein may be adapted to any type of content scheduling tool, and to other types of scheduling tools. Furthermore, additional structural and operational embodiments, including modifications/alterations, will become apparent to persons skilled in the relevant art(s) from the teachings herein.

Embodiments of the present invention assist content programmers/producers in programming their websites by reporting the performance of past content programming. In further embodiments, a forecast of the performance of possible future content programming is enabled to be made.

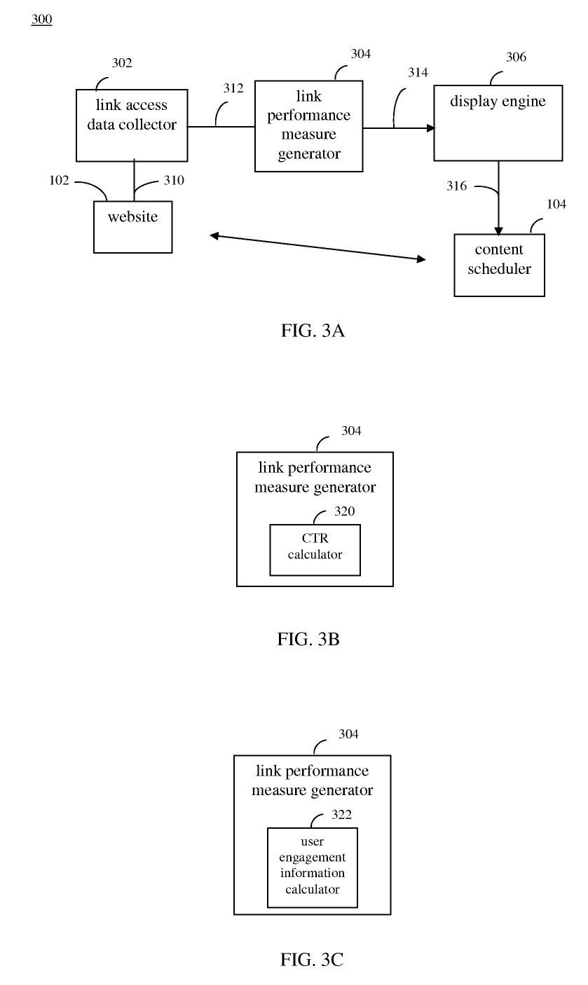

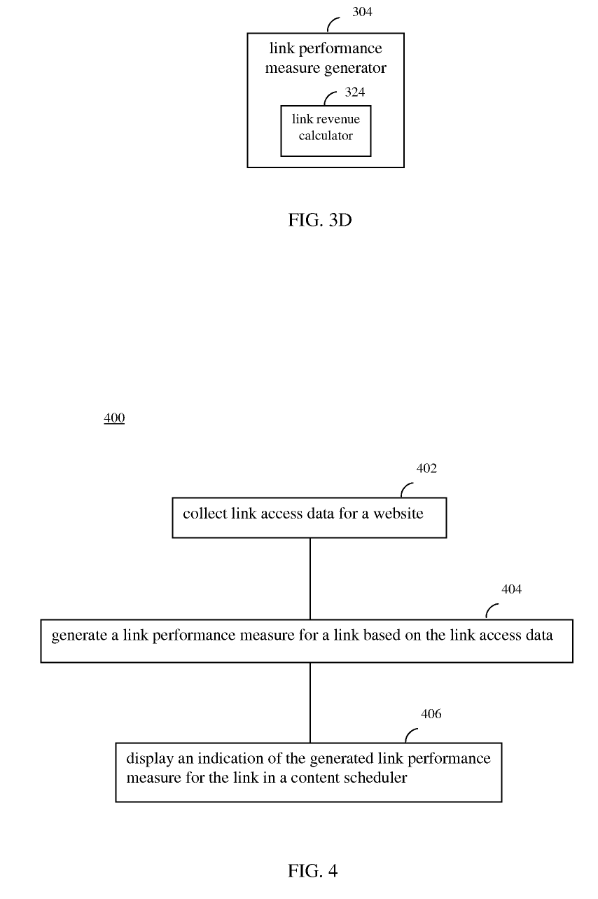

FIG. 3A shows a content programming system 300, according to an embodiment of the present invention. As shown in FIG. 3A, system 300 includes a link access data collector 302, a link performance measure generator 304, a display engine 306, and content scheduler 104. Content scheduling system 300 enables a content programmer to schedule content in website 102 using content scheduler 104. Link performance information is provided graphically to the content programmer in content scheduler 104, to aid the content programmer in making scheduling decisions.

FIG. 4 shows a flowchart 400 providing example steps for operation of content programming system 300, according to an example embodiment of the present invention. Flowchart 400 is described as follows. Other structural and operational embodiments will be apparent to persons skilled in the relevant art(s) based on the following discussion.

Flowchart 400 begins with step 402. In step 402, link access data for a website is collected. In an embodiment, link access data collector 302 performs step 402. As shown in FIG. 4, link access data collector 302 is coupled to website 102 by a first communication link 310. Link access data collector 302 is configured to collect link access data for website 102. Link access data collector 302 may be configured to collect a variety of types of link access data. For example, link access data collector 102 may count accesses or “clicks” of links in webpages of website 102, may count how many times webpages containing particular links are viewed (also known as counting “link impressions”), may collect user engagement related information (e.g., a number of subsequent webpage views by a user resulting from clicking a link ), may collect revenue generated by clicking particular links, and/or may count or otherwise collect other data regarding accesses of links of website 102. Link access data collector 302 transmits the collected link access data to link performance measure generator 304 over a second communication link 312.

In step 404, a link performance measure for a link is generated based on the stored link access data. In an embodiment, link performance measure generator 304 performs step 404. Link performance measure generator 304 may be configured to generate any type of measures that provide an indication of link performance. For example, FIGS. 3B-3D show block diagrams for link performance measure generator 304 that indicate example functionality, according to embodiments of the present invention.

As shown in FIG. 3B, link performance measure generator 304 may include a click through rate (CTR) calculator 320. CTR calculator 320 is configured to calculate a click through rate for one or more links of website 102 based on the link access data received over second communication link 312. In an embodiment, a click through rate, CTR, for a link is calculated according to Equation 1 shown as follows:

CTR=NOC/NOV, Equation 1

where:
NOC=a number of clicks of the link, and
NOV=a number of views of the link.
   For example, the CTR for a link may be determined for a particular time period, such that NOC is the number of clicks of the link that occurred during the time period, and NOV is the number of views of the link that occurred during the time period. CTR calculator 320 generates a calculated CTR for one or more links, and transmits the calculated CTR(s) to display engine 306 over a third communication link 314.

In another example, as shown in FIG. 3C, link performance measure generator 304 may include a user engagement information calculator 322. User engagement information calculator 322 is configured to calculate user engagement related information. Such information provides an indication of how well a particular link engages a user with website 102. For example, user engagement information calculator 322 may calculate a number of webpages subsequently viewed by a user directly resulting from clicking on a particular link. Such a calculation may be made by tracing a chain of webpage viewings made by a user in the collected link access data received from link access data collector 302. User engagement information calculator 322 generates user engagement information for one or more links, and transmits the calculated user engagement information to display engine 306 over third communication link 314.

In another example, as shown in FIG. 3C, link performance measure generator 304 may include a link revenue calculator 324. Link revenue calculator 324 is configured to calculate revenue information related to a link based on the link access data received over second communication link 312. For example, the link access data may include an indication of revenue generated for each click of a link. Link revenue calculator 324 may sum or otherwise process the indications of revenue for a link, including categorizing the types of revenue, and transmit the calculated revenue information to display engine 306 over third communication link 314.

In step 406, an indication of the generated link performance measure for the link is displayed in a content scheduler. In an embodiment, display engine 306 performs step 406. Display engine 306 receives the performance measure for the link over third communication link 314. Display engine 306 is configured to generate a graphical indication of the performance measure for the link that can be displayed by content scheduler 104. Display engine 306 can generate information to enable display engine 306 to display a variety of types of graphical indications of performance measures for links. For example, the graphical indication may be a rectangular, round, or other shaped polygon, an icon, or an otherwise shaped graphical item. The graphical indication may have a shape, a range of colors or grayscales, or other attribute that is proportional or indicative of the generated performance measure for the link. Display engine 306 may include a rendering engine, or may interface with a rendering engine of content scheduler 104, to enable content scheduler 104 to display the graphical indication based on the generated link performance measure. The graphical indication may be displayed overlaid or adjacent to corresponding link data displayed by content scheduler 104. Display engine 306 transmits generated information regarding the graphical indication to content scheduler 104 over a fourth communication link 316.

Link access data collector 302, link performance measure generator 304, and display engine 306 may be implemented in hardware, software, firmware, of any combination thereof. For example, link access data collector 302, link performance measure generator calculator 304, and display engine 306 may each be implemented in digital logic, such as in an integrated circuit (e.g., an application specific integrated circuit (ASIC)), in code executing in one or more processors, and/or in other manner as would be known to persons skilled in the relevant art(s). First, second, third, and fourth communication links 310, 312, 314, and 316 may each include any type of communication link, or combination of communication links, wired and/or wireless, to enable the respective components of system 300 to communicate with each other as needed. For example, communication links 310, 312, 314, and 316 may include communications links through networks such as local area networks (LAN) and/or wide area networks (WAN) such as the Internet. In embodiments where one or more of link access data collector 302, link performance measure generator 304, display engine 306, and content scheduler 104 are located in the same computer system or in nearby computer systems, communication links 310, 312, 314, and 316 may include communications links over internal computer buses (serial or parallel), FIREWIRE links, USB links, and/or other types of communication links.

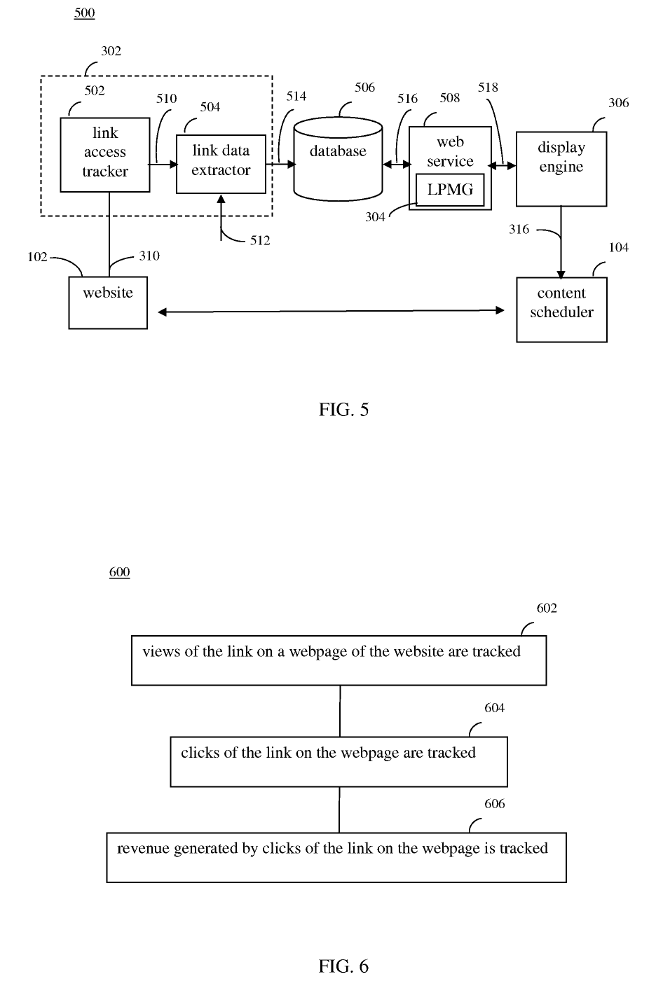

FIG. 5 shows a block diagram of a content programming system 500, which is an example of content programming system 300 shown in FIG. 3A, according to embodiment of the present invention. As shown in FIG. 5, link performance collector 302 includes a link access tracker 502 and a link data extractor 504. Furthermore, a web service 508 is present that includes link performance measure generator 304. A database 506 is coupled between link data extractor 504 and web service 508.

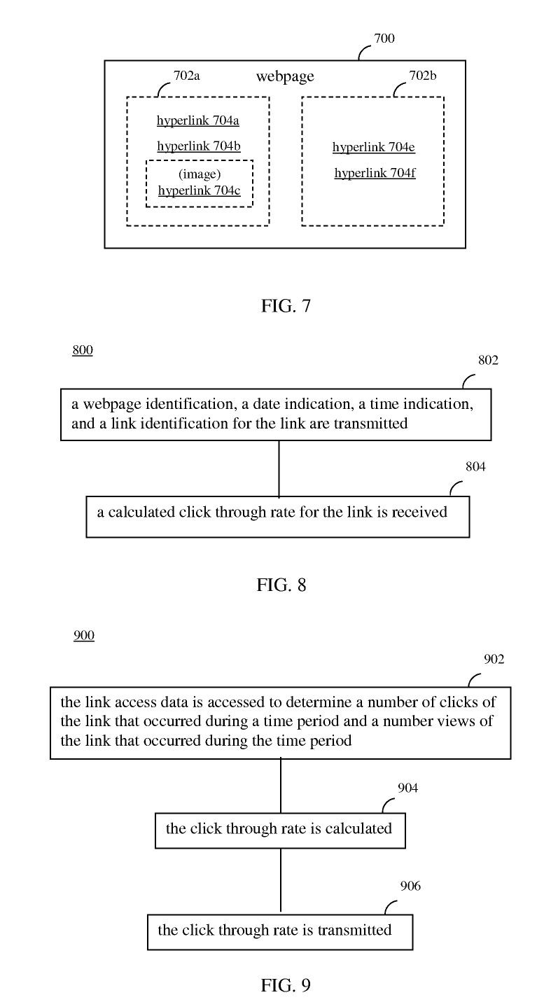

Link access tracker 502 is configured to track information related to accesses of links present in one or more webpages of website 102. In an embodiment, link access tracker 502 performs one or more of the steps shown in flowchart 600 in FIG. 6 for each link. Flowchart 600 is described as follows. In step 602 of flowchart 600, views of the link on a webpage of the website are tracked. For example, FIG. 7 shows an example webpage 700, which may be a webpage of website 102. Webpage 700 includes a first module 702a and a second module 702b. First module 702a includes a first hyperlink 704a, a second hyperlink 704b, and a third hyperlink 704c. Second module 702b includes a fourth hyperlink 704d and a fifth hyperlink 704e. First, second, fourth, and fifth hyperlinks 704a, 704b, 704d, and 704e are hyperlinks based on hypertext, while third hyperlink 704c is a hyperlink based on a graphical element (e.g., an image).

In an embodiment, for each of hyperlinks 704a-704e, link access tracker 502 counts views of webpage 700 that are made when the respective hyperlink is present on webpage 700. The page views for each of hyperlinks 704a-704e are tracked in a page view log or list (e.g., a data array). Each of hyperlinks 704a-704e may be uniquely identified in the list in a variety of ways, such as by using the following three ULT (universal link tracking) parameters: sec (module name), pos (position with the module), and slk (a portion or the entire link name). Furthermore, link access tracker 502 stores a timestamp in the list for each listed view of a hyperlink. Link access tracker 502 stores each webpage/hyperlink view event in the list for each hyperlink in an ongoing manner.

In step 604, clicks of the link on the webpage are tracked. In an embodiment, link access counter 502 tracks each access of each of hyperlinks 704a-704e, such as accesses by a user that points and clicks on the respective hyperlink. The clicks of each of hyperlinks 704a-704e are tracked in a link click log or list (e.g., a data array), which may be the same or different list used to track views (in step 602). Link access tracker 502 identifies each hyperlink in the list, such as through the use of the ULT parameters. Furthermore, link access tracker 502 stores a timestamp in the list for each listed click of a hyperlink. Link access tracker 502 stores each hyperlink click event in the list for each hyperlink in an ongoing manner.

In step 606, revenue generated by clicks of the link on the webpage is tracked. In an embodiment, link access counter 502 tracks revenue generated for each access of each of hyperlinks 704a-704e, such as accesses by a user that points and clicks on the respective hyperlink. The revenue for each click of hyperlinks 704a-704e may be tracked in a link revenue log or list (e.g., a data array), which may be the same or different list used to track views (in step 602). Link access tracker 502 identifies an amount of revenue (when present) for each click instance in the list. Furthermore, link access tracker 502 stores a timestamp in the list for each listed revenue indication. Link access tracker 502 stores each revenue generation instance in the list for each hyperlink in an ongoing manner.

Revenue information for link accesses may be collected by link access counter 502 from various sources. A stored table may indicate an amount of revenue generated by a link each time the link is accessed. The table, or an alternative form of the revenue information, may be imbedded in website 102, may be obtained from a related website, or may be stored by link access tracker 502. Various types of revenue generation may be encompassed by embodiments of the present invention. For example, a link access can generate revenue directly and/or indirectly. In a “direct” example, in a text advertisement example, an advertiser may pay an operator/owner of website 102 a fixed amount of revenue for each click of a link. Alternatively, in an “indirect” example, a link click may lead to a webpage where an advertisement is displayed. An advertiser may pay an operator/owner of website 102 a pre-determined amount of revenue each time the advertiser's advertisement is displayed. Revenue generated by these and other link revenue generation techniques may be tracked by link access tracker 502.

In embodiments, steps 602-606 may be performed by a conventionally available or proprietary hyperlink access tracking tool. Many such webpage/link access tracking tools are readily available, and would be known to persons skilled in the relevant art(s).

Referring back to FIG. 5, link access tracker 502 outputs link access data 510, which includes one or more logs/lists of page view, link tracking information, revenue generation information, etc., for one or more hyperlinks. For example, link access data 510 may include access information for one or more links and/or time periods collected since a prior transmit of such access information.

Link data extractor 504 receives link access data 510. Furthermore, in an embodiment, link data extractor 504 receives a selection signal 512. Link data extractor 504 is configured to extract from link access data 510 view counts and click counts, revenue information, and/or other type of link access information specified by selection signal 512. Selection signal 512 can be configured to specify view counts, click counts, revenue, etc., in a variety of ways. For example, selection signal 512 can specify one or more of a website, a webpage, a module, a specific hyperlink, a specific date, a specific time period, etc., to select specific link access data of interest.

In an example embodiment, link selection signal 512 includes the following specified parameters:
propertyid: a website,
spaceid: a webpage of the website (propertyid),
modules to ignore: one or more modules of the webpage (spaceid) not of interest, and
date: a date of interest for link access information related to hyperlinks.
   In this example, link data extractor 504 generates page view counts, click counts, revenue information totals, and/or other link access data covered by the page view list, link click list, revenue list, and/or other list received in link access data 510 for links that were present in the website of propertyid, on the webpage of spaceid, in one or more modules of the webpage of spaceid that are not ignored according to “modules to ignore,” and that occurred on the indicated date. For example, assuming that links of website 700 shown in FIG. 7 are of interest, link selection signal 512 may include the following parameter values:
propertyid: website 102,
spaceid: webpage 700,
modules to ignore: module 702b, and
date: date X.
   In this example, link data extractor 504 generates link access information for views and clicks occurring on “date X” for links of website 102 on webpage 700 in module 702a (not module 702b, which is ignored). Thus, page view, click counts, revenue information, etc., for views and clicks of hyperlinks 704a-704c (not hyperlinks 704d and 704e) shown in FIG. 7 are generated.

In an embodiment, link data extractor 504 generates page view, click counts, revenue information, and/or other link access data categorized by time period. The time period basis used may be any desired time period. For example, the time period basis may be 15 minutes, 30 minutes, an hour, two hours, 24 hours, etc. For instance, in the current example, assume that the time period basis is hourly. Thus, in the current example, link data extractor 504 generates page view and click counts on an hourly basis for “date X” for each of hyperlinks 704a-704c. Table 1 shows example page view and click counts for hyperlinks 704a-704c on “date X” categorized on an hourly basis:

TABLE 1

| | 00:00-01:00 | 01:00-02:00 | 02:00-03:00 | . . . | 23:00-24:00 |
|---|---|---|---|---|---|
| hyperlink | 2 views | 12 view | 15 views | | 5 views |
| 704a | 0 clicks | 3 clicks | 5 click | | 4 clicks |
| hyperlink | 2 views | 12 views | 15 views | | 5 views |
| 704b | 0 clicks | 6 clicks | 8 clicks | | 2 clicks |
| hyperlink | 2 views | data N/A | 15 views | | 5 views |
| 704c | 1 clicks | | 3 clicks | | 1 clicks |

In another embodiment, Table 1 may include revenue generated for each link during each time period, and/or other types of link access data that occurred for each link during each time period.

As shown in FIG. 5, link data extractor 504 generates extracted link access data 514, which includes the link access data extracted from link access data 510. Database 506 receives and stores the data of extracted link access data 514. In an embodiment, database 506 is a MySQL database management system, and the data of extracted link access data 514 is stored as a MySQL table by database 506. Alternatively, database 506 may be another type of database system, and/or the data may be stored in another manner, as would be known to persons skilled in the relevant art(s).

Link data extractor 504 may be implemented in hardware, software, firmware, or any combination thereof, to perform its functions. For example, link data extractor 504 may be implemented in digital logic, such as in an integrated circuit (e.g., an application specific integrated circuit (ASIC)), in code executing in a processor, and/or in other manner as would be known to persons skilled in the relevant art(s). For example, in an embodiment, link data extractor 504 is implemented as an ETL (extract, transform, load) script using a scripting language, such as PERL, JavaScript, or other scripting language known to persons skilled in the relevant art(s). In an embodiment, link data extractor 504 may be executed on a periodic basis, such as daily or hourly. For example, link data extractor 504 may be executed by a cron service in a UNIX OS (operating system) embodiment for a computer system that hosts link data extractor 504.

As shown in FIG. 5, web service 508 is coupled between database 506 and display engine 306. Web service 508 enables display engine 306 to access link access data stored in database 506. Furthermore, web service 508 includes link performance measure generator 304, and thus can calculate link performance information for display engine 306. In an embodiment, web service 508 is a web service software system operating on a server that enables machine-to-machine interaction. In an embodiment, display engine 306 communicates with web service 508 in a manner prescribed by a web service description provided by web service 508, in messages formatted according to Service Oriented Architecture Protocol (SOAP). In another embodiment, an alternative type of entity (including hardware and/or software) is used in place of web service 508 to perform the functions described herein for web service 508.

Display engine 306 may desire click through rate information, revenue information, user engagement information, and/or other performance measure information regarding one or more links being scheduled in content scheduler 104. To receive this information, display engine 306 may communicate with web service 508 according to flowchart 800 shown in FIG. 8. Flowchart 800 is described as follows.

In step 802 of flowchart 800, a webpage identification, a date indication, a time indication, and a link identification for the link are transmitted. For example, according to step 802, display engine 306 may transmit the following information in a link performance measure request over a communication link 518 to web service 508:
spaceid: a webpage of a website,
datestamp: a date of interest,
hour: an hour of interest, and
link identification: information identifying a particular link (such as a ULT link identifier).
   In alternative embodiments, further, less, and/or alternative information than shown above may be provided by display engine 306 in a link performance request to identify a link, depending on the particular implementation.

Steps 804 and 806 shown in FIG. 8 relate to an embodiment where the link performance measure request has requested CTR information for a link. Steps 804 and 806 can be adapted to handle a request for other types of link performance measure information, including user engagement information and/or link revenue information.

In step 804, a calculated click through rate for the link is received. For example, according to step 804, web service 508 uses CTR calculator 320 of FIG. 3B to generate a CTR for the link(s) identified in the received CTR request, and transmits the calculated CTR information back to display engine 306. In a user engagement embodiment, user engagement information calculator 322 of FIG. 3C may receive a request to generate user engagement information for the link(s) identified in the received request. In a revenue embodiment, link revenue calculator 324 may receive a request to generate link revenue information for the identified link(s) in the request.

For instance, following the example above, the request of step 802 may include the following information:
spaceid: webpage 700,
datestamp: date X,
hour: 01:00-02:00, and
link identification: hyperlink 704b.
   Using the example link access data of Table 1 for a CTR embodiment, the calculated CTR received in step 804 is 0.5 (6 clicks/12 views).

The just described interaction between web service 508 and display engine 306 is now described from the perspective of web service 508. To process the link performance measure request, web service 508 may operate according to flowchart 900 shown in FIG. 9. Flowchart 900 relates to an example CTR embodiment, but may be adapted to other types of link performance measure requests, including user engagement and link revenue.

In step 902, the link access data is accessed to determine a number of clicks of the link that occurred during a time period and a number views of the link that occurred during the time period. For example, as shown in FIG. 5, web service 508 communicates with database 506 over a communication link 516. Web service 508 accesses the link access data stored in database 506. Referring to the example link access data of Table 1 in database 506, web service 508 may access database 506 for hyperlink 704b located on webpage 700, on date X and time period 01:00-02:00, resulting in a stored number of views of 12, and a stored number of clicks of 6.

In step 904, the click through rate is calculated. For example, the CTR may be calculated according to Equation 1 above (CTR=NOC/NOV). In the current example, CTR=6/12=0.5.

In step 906, the click through rate is transmitted. For example, as shown in FIG. 5, web service 508 transmits the calculated CTR to display engine 306 over communication link 518.

Note that in an embodiment, if database 506 does not store link access data needed to generate particular performance information for a particular link, web service 508 may be configured to generate a link performance estimate. For example, in a CTR embodiment, web service 508 may be configured to generate an estimate of a click through rate for a link for a selected time period. If web service 508 cannot locate link access data in database 506 that matches the CTR request information, an estimated CTR may be generated. The estimated CTR may be returned by web service 508 to display engine 306. In an embodiment, an indication that the returned CTR is an estimate is also returned. Such estimates may be used to forecast CTRs for links. Estimates for other types of link performance measures may also be made, including estimates for user engagement and link revenue performance measures.

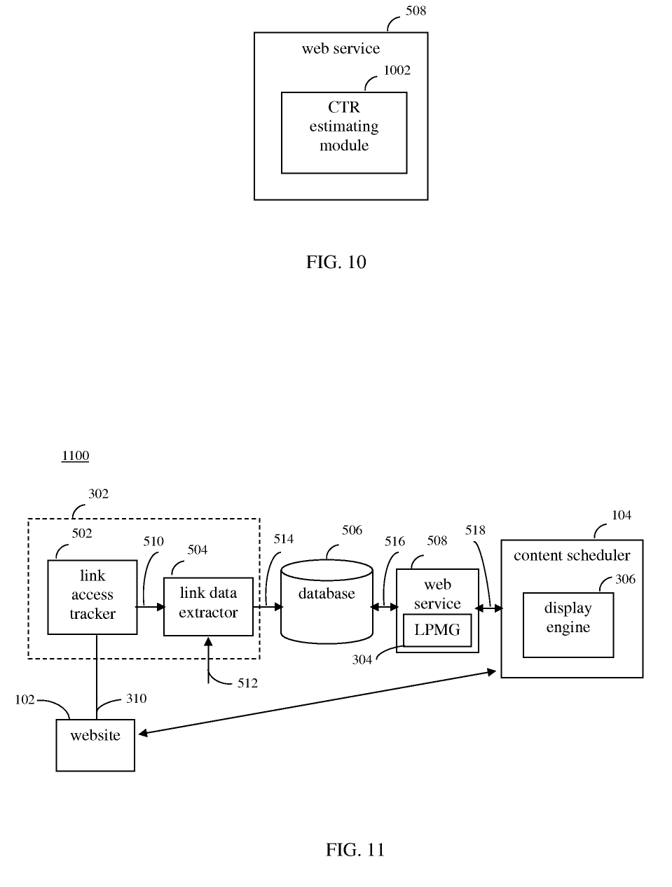

For example, FIG. 10 shows web service 508 including a CTR estimating module 1002, according to an embodiment of the present invention. A variety of types of estimates may be generated by CTR estimating module 1002. In an example embodiment, CTR estimating module 1002 may estimate a CTR for a link for a selected time period by determining an average click through rate for the link over a time period greater than the selected time period, including using link access data for the link from all time periods that such performance data is available for the link.

For example, referring to Table 1, any number of one hour time periods can be used to calculate an estimated CTR. Assuming that link access data is not present for hyperlink 704c in the time period 01:00-02:00, the link access data present for hyperlink 704c in time periods 00:00-01:00 and 02:00-03:00 may be used to generate an average CTR to be used as an estimated CTR for time period 01:00-02:00. A first CTR for hyperlink 704c for time period 00:00-01:00 equals 1 click/2 views=0.5. A second CTR for hyperlink 704c for time period 02:00-03:00 equals 3 clicks/15 views=0.2.

An average CTR can be calculated according to Equation 2 as follows:

Average CTR=ΣCTRs/# of CTRs Equation 2

For Equation 2, a CTR is calculated for each time period, and the CTRs are summed, to calculate the numerator. The number of time periods for which as CTR is generated is used for the denominator. Alternatively, an average CTR can be calculated according to Equation 3 as follows:

Average CTR=Σclicks/Σ views Equation 3

For Equation 3, the number of clicks across time periods is summed to calculate the numerator, and the number of views across time periods is summed to calculate the denominator. Using the data of the current example, according to Equation 2, Average CTR=(0.5+0.2)/2=0.35. According to Equation 3, Average CTR=(1+3)/(2+15)=0.235. Estimated CTRs may be generated in further ways, as would be known to persons skilled in the relevant art(s).

In embodiments, communication link 518 may include communications links through networks such as local area networks (LAN) and/or wide area networks (WAN) such as the Internet. Web service 508 may be accessed by multiple display engines 306 over a network such as the Internet. For example, the multiple display engines may correspond to multiple content schedulers 104 being used by content programmers to schedule content related to one or more websites having link access data stored in database 506. Link access tracker 502, link data extractor 504, and database 506 may be located in the same computer system, in computer systems located in a LAN, or in computer systems accessible to each other over a WAN such as the Internet.

As described above, display engine 306 receives a calculated performance measure for a link from web service 508. Display engine 306 is configured to generate a graphical indication of the calculated performance measure for the link that can be displayed by content scheduler 104. As shown in the example of FIG. 5, display engine 306 may be located external to content scheduler 104. In another embodiment, such as shown in FIG. 11, display engine 306 may be located internal to content scheduler 104.

For example, display engine 306 may be coupled to, or incorporated in a display engine conventionally present in content scheduler 104.

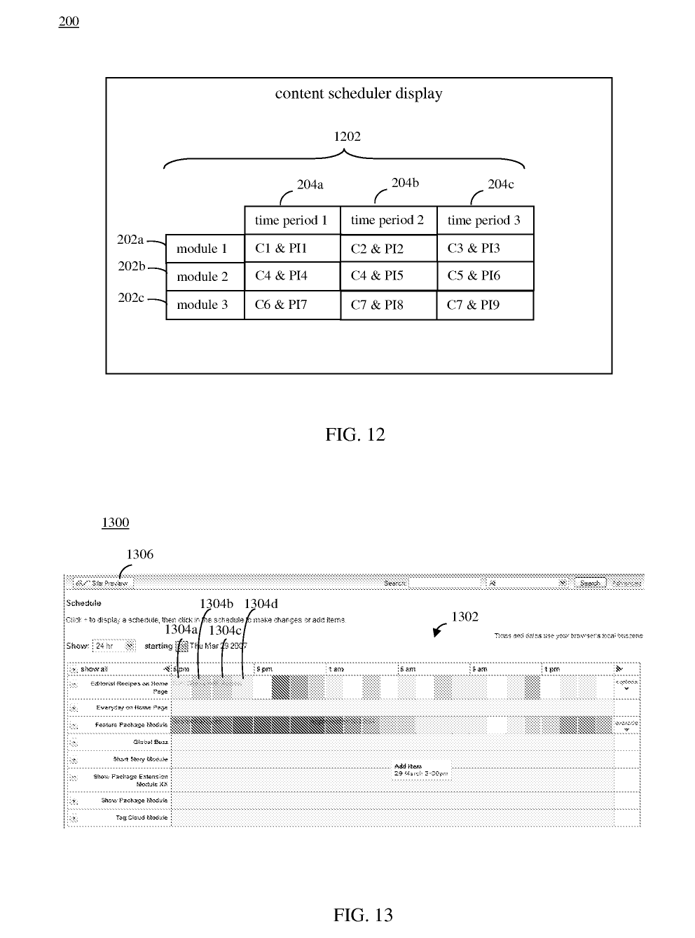

Display engine 306 can generate various graphical indications used to indicate link performance measures in various displays provided by content scheduler 104. For example, as described above, FIG. 2 shows an example display 200 generated by content scheduler 104. Display 200 provides a timeline that enables a content programmer to view and schedule content included in a selected webpage of website 102. According to an embodiment, link performance information, such as generated CTRs, user engagement information, link revenue, etc., received by display engine 306, can be graphically incorporated into display 200 to assist a content programmer with content scheduling. For example, FIG. 12 shows display 200 of FIG. 2 displaying a content schedule timeline table 1202 similar to content schedule timeline table 206 of FIG. 2, but with the inclusion of link performance measure information. In the example of FIG. 2 described above, a content schedule timeline for each of modules 1-3 is shown on a row-by-row basis. In FIG. 12, a content schedule timeline with link performance measure information for each of modules 1-3 is shown on a row-by-row basis.

As shown in table 1202, for module 1, first content (C1) is scheduled for time period 1. Furthermore, a first graphical link performance indication (PI1) is present overlapping first content C1 in table 1202, providing an indication of the performance of links appearing in module 1 during time period 1, such as CTR, user engagement, link revenue, etc. In the example of FIG. 12, graphical link performance indications may be configured to provide an indication of an average CTR for multiple links that are present in a module during each time period. For example, the first graphical link performance indication PI1 provides a graphical indication of an average CTR for links that are present in module 1 during time period 1. The average CTR for links present in a module can be calculated in a similar manner as described above with regard to Equations 2 or 3, or another fashion.

Furthermore for module 1, second content (C2) is scheduled for time period 2, and a second graphical link performance indication (PI2) is present overlapping second content C2, providing an indication of the performance of links appearing in module 1 during time period 2. For example, PI2 provides a graphical indication of an average CTR for links that are present in module 1 during time period 2. Third content (C3) is scheduled for time period 3, and a third graphical link performance indication (PI3) is present overlapping third content C3, providing an indication of the performance of links appearing in module 1 during time period 3.

For module 2, fourth content (C4) is scheduled for time period 1 and time period 2. A fourth graphical link performance indication (PI4) is present overlapping fourth content C4 in time period 5, and a fifth graphical link performance indication (PI5) is present overlapping fourth content C4 in time period 5. PI4 and PI5 respectively provide an indication of the performance of links appearing in module 2 for fourth content C4 during time periods 1 and 2.

For purposes of brevity, graphical performance indications PI6-PI9 in the remainder of table 1202 in FIG. 12 are not described, as they would be understood by persons skilled in the relevant art(s) from the teachings herein.

The graphical indications of PI1-PI9 may have any desired graphical attribute to convey an indication of a link performance measure for the corresponding module in the corresponding time period. For example, PI1-PI9 may each be a rectangular, round, or other shaped polygon, an icon, or an otherwise shaped graphical item. PI1-PI9 may each have a shape, a range of colors or grayscales, or other attribute that is proportional or indicative of the performance measure. The graphical indication may be displayed overlaid or adjacent to corresponding one of contents C1-C9 displayed by content scheduler 104.

For instance, FIG. 13 shows a display 1300 of a content scheduler, having a content schedule timeline table 1302, according to an embodiment of the present invention. Table 1302 includes eight rows, where each row is a timeline of content for a corresponding module in a webpage. The first row of table 1302 is a module titled “Editorial Recipes on Home Page.” Example content is shown in the first row of table 1302. For example, content titled “Pork Chops with Apples” is present in the module represented by the first row. Table 1302 shows six segmented columns representing time starting on Thursday Mar. 29, 2007, where each column is four hours wide. The first column covers a time period that starts at 5 pm and ends at 9 pm; the second column starts at 9 pm and ends at 1 am, etc. Each column includes four hour long graphical performance indicators that indicate an average CTR for links that are present in the corresponding module during the particular hour. For instance, first through fourth graphical indications 1304a-1304d are shown for the module of the first row, indicating an average CTR for links present in the “Editorial Recipes on Home Page” module relating to the “Pork Chops with Apples” content during the hour periods of 5 pm-6 pm, 6 pm-7 pm, 7 pm-8 pm, and 8 pm-9 pm. As shown in FIG. 13, graphical indications 1304a-1304d are grayscale graphical indicators, although alternatively they may be color coded or other type of graphical indicator.

In such a grayscale embodiment, a white graphical indicator 1304 may indicate an average CTR of zero, or other minimum CTR amount, while a black graphical indicator 1304 may indicate a maximum average CTR amount, which may be predetermined or may be determined for the present content. A grayscale graphical indicator 1304 between white and black indicates an average CTR between the minimum and maximum amounts, proportional to its gray level.

Alternatively, graphical indicators 1304 may indicate other link performance information, such as percentage changes in average CTR from a prior date for the same module according to their particular grayscale level, or may represent average CTR in another manner. In another embodiment, the graphical indicators 1304 indicate whether scheduled content performed above or under an average level indicated by a center grayscale.

A range of colors may be used to represent variations in link performance, in an analogous fashion to the grayscale graphical indications described above. In one example, a module having a relatively high level of activity (e.g., relatively high CTR, user engagement, link revenue, etc.) may be indicated with red, while a module having a relatively low level of activity may be indicated with blue. A module performing averagely could be indicated with green. Other color indications may alternatively be implemented.

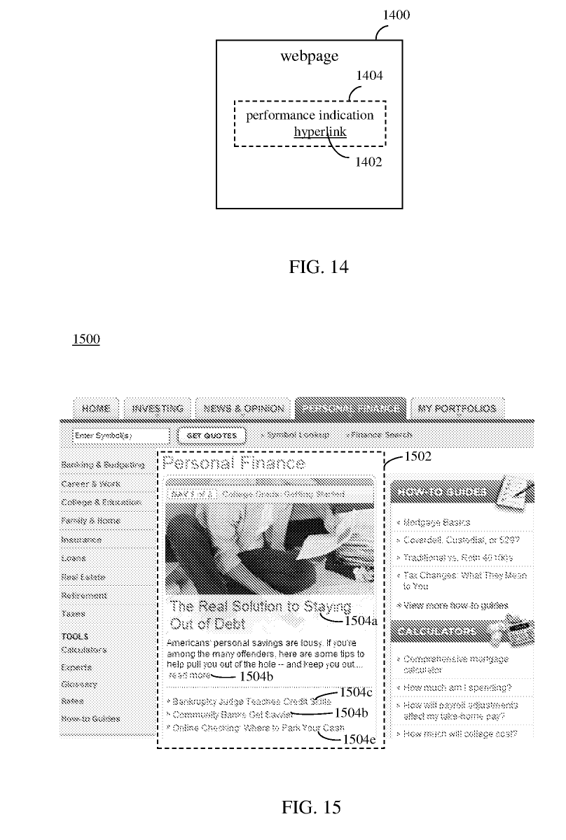

In another embodiment, display engine 306 can generate graphical indications used to indicate link performance in a webpage being programmed by content scheduler 104. For example, as described above, FIG. 14 shows an example webpage 1400 displayed by content scheduler 104. For example, webpage 1400 may be displayed by content scheduler 104 as a preview webpage, to indicate how the currently programmed content would appear in a webpage prior to actually making the webpage accessible over the Internet. In an embodiment, a content programmer viewing a content schedule timeline table, such as table 1202 shown in FIG. 12, can select a particular time to preview the website being scheduled with the currently selected programming indicated in the table. For example, in FIG. 13, a site preview button 1306 may be selected to display a preview webpage, such as webpage 1400. The preview webpage can have graphical link performance information according to embodiments.

In a similar fashion to webpage 700 shown in FIG. 7, webpage 1400 includes a hyperlink 1402. Furthermore, a graphical performance indication 1404 is shown overlaid on hyperlink 1402. In an embodiment, graphical performance indication 1404 provides a graphical indication of CTR or other performance measure for hyperlink 1402. Similarly to above for graphical performance indications PI1-PI9 in FIG. 12, graphical performance indication 1404 may have any desired graphical attribute to convey an indication of link performance for the corresponding module in the corresponding time period.

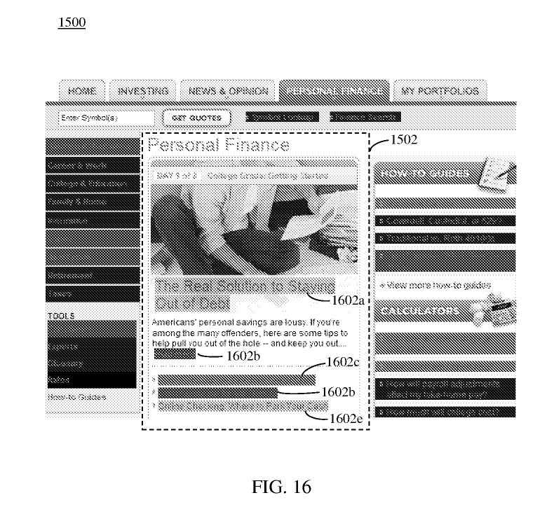

For example, FIG. 15 shows an example preview webpage 1500. Webpage 1500 includes various modules, including a module 1502 titled “Personal Finance.” Module 1502 includes a plurality of hyperlinks 1504a-1504e. Link performance measure data is not indicated in FIG. 15. FIG. 16 shows webpage 1500 with graphical performance measure indications overlaid on hyperlinks. For example, graphical performance indications 1602a-1602e are overlaid on hyperlinks 1504a-1504e. Graphical performance indications overlaid on hyperlinks in a webpage may be also referred to as a link “heat map,” reflecting link performance information across the webpage. Alternatively, a module “heat map” may be used to reflecting module activity. Thus, according to embodiments of the present invention, display engine 306 may be configured to generate a link heat map and/or a module heat map.

As shown in FIG. 16, graphical indications 1602a-1602e are grayscale graphical indicators. A grayscale graphical indicator 1602 indicates a CTR, user engagement, link revenue, and/or other link performance measure for the overlaid hyperlink 1504, proportional to its gray level. Alternatively, graphical indications 1602 may indicate percentage changes in a link performance measure from a prior date for the same link according to their particular grayscale level, or may represent a link performance measure in another manner. Furthermore, while grayscale is shown for illustrative purposes, graphical indications 1602 may have any desired graphical attribute to convey a link performance measure. For graphical indications 1602 may be rectangular, round, or other shaped polygon, an icon, or an otherwise shaped graphical item, to convey the link performance measure. Graphical indications 1602 may have a range of colors or grayscales, or other attribute that is proportional or indicative of the generated link performance measure. Graphical indications 1602 may be displayed overlaid or adjacent to corresponding links displayed by content scheduler 104.

### Example Computer Implementation

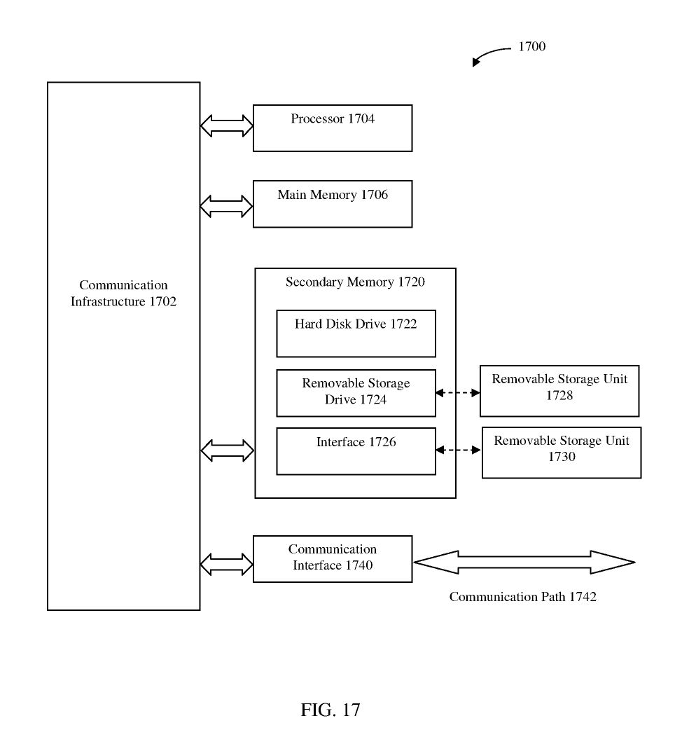

In an embodiment of the present invention, the system and components of the present invention described herein are implemented using well known servers/computers, such as computer 1702 shown in FIG. 17. For example, link access data collector 302, link performance measure generator 304, display engine 306, and content scheduler 104 can be implemented using computers 1702.

Computer 1702 can be any commercially available and well known computer capable of performing the functions described herein, such as computers available from International Business Machines, Apple, Sun, HP, Dell, Compaq, Digital, Cray, etc.

Computer 1702 includes one or more processors (also called central processing units, or CPUs), such as a processor 1706. Processor 1706 is connected to a communication bus 1704. In some embodiments, processor 1706 can simultaneously operate multiple computing threads.

Computer 1702 also includes a main or primary memory 1708, such as random access memory (RAM). Primary memory 1708 has stored therein control logic 1728A (computer software), and data.

Computer 1702 also includes one or more secondary storage devices 1710. Secondary storage devices 1710 include, for example, a hard disk drive 1712 and/or a removable storage device or drive 1714, as well as other types of storage devices, such as memory cards and memory sticks. Removable storage drive 1714 represents a floppy disk drive, a magnetic tape drive, a compact disk drive, an optical storage device, tape backup, etc.

Removable storage drive 1714 interacts with a removable storage unit 1716. Removable storage unit 1716 includes a computer useable or readable storage medium 1724 having stored therein computer software 1728B (control logic) and/or data. Removable storage unit 1716 represents a floppy disk, magnetic tape, compact disk, DVD, optical storage disk, or any other computer data storage device. Removable storage drive 1714 reads from and/or writes to removable storage unit 1716 in a well known manner.

Computer 1702 also includes input/output/display devices 1722, such as monitors, keyboards, pointing devices, etc.

Computer 1702 further includes a communication or network interface 1718. The network interface 1718 enables the computer 1702 to communicate with remote devices. For example, network interface 1718 allows computer 1702 to communicate over communication networks or mediums 1724B (representing a form of a computer useable or readable medium), such as LANs, WANs, the Internet, etc. Network interface 1718 may interface with remote sites or networks via wired or wireless connections.

Control logic 1728C may be transmitted to and from computer 1702 via the communication medium 1724B. More particularly, computer 1702 may receive and transmit carrier waves (electromagnetic signals) modulated with control logic 1730 via communication medium 1724B.

Any apparatus or manufacture comprising a computer useable or readable medium having control logic (software) stored therein is referred to herein as a computer program product or program storage device. This includes, but is not limited to, computer 1702, main memory 1708, secondary storage devices 1710, removable storage unit 1716 and carrier waves modulated with control logic 1730. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method for data-assisted content programming, comprising:
collecting link access data for a website;
calculating a link performance measure for a link based on the link access data; and
graphically displaying an indication of the calculated link performance measure for the link in a content scheduler.

2-4. (canceled)

5. The method of claim 1, wherein said calculating a link performance measure for a link based on the link access data comprises:
calculating a total revenue generated for the link based on one or more clicks of the link occurring during a specified time period.

6. The method of claim 1, wherein said calculating a link performance measure for a link based on the link access data comprises:
calculating a user engagement measure for the link based one or more clicks of the link and views of webpages resulting from the one or more clicks of the link.

7. The method of claim 1, wherein said calculating a link performance measure for a link based on the link access data comprises:
transmitting a webpage identification, a date indication, a time indication, and a link identification for the link to an entity; and
receiving a generated link performance measure for the link from the entity.

8. The method of claim 1, wherein said calculating a link performance measure for a link based on the link access data comprises:
calculating a click through rate for a link based on the link access data

9. The method of claim 8, wherein said collecting link access data for a website comprises:
tracking views of the link on a webpage of the website; and
tracking clicks of the link on the webpage.

10. The method of claim 9, wherein said collecting link access data for a website further comprises:
tracking time of occurrence data for the tracked views and tracked clicks.

11. The method of claim 10, wherein said collecting link access data for a website further comprises:
extracting from the link access data a view count and a click count for views and clicks that occurred during a specified time period for each link of a specified webpage.

12. The method of claim 11, wherein said extracting further comprises:
ignoring link access data relating to links of a specified module of the specified webpage.

13. The method of claim 8, wherein said calculating a click through rate for a link based on the link access data comprises:
accessing the link access data to determine a number of clicks of the link that occurred during a time period and a number views of the link that occurred during the time period; and
calculating the click through rate, CTR, for the link according to
CTR=NOC/NOV,
where
NOC is the determined number of clicks of the link that occurred during the time period, and
NOV is the determined number of views of the link that occurred during the time period.

14. The method of claim 1, wherein calculating a link performance measure for a link based on the link access data comprises:
estimating a link performance measure for the link for a selected time period.

15. The method of claim 14, wherein the link performance measure is a click through rate for the link, wherein said estimating comprises:
determining an average click through rate for the link over a time period greater than the selected time period.

16. The method of claim 1, wherein said graphically displaying an indication of the calculated link performance measure for the link in a content scheduler comprises:
displaying a webpage configured according to the content scheduler, the displayed webpage including the link; and
displaying on the displayed webpage a graphical indication of the calculated link performance measure overlaid on the link.

17. The method of claim 16, wherein said graphically displaying an indication of the calculated link performance measure for the link in a content scheduler further comprises:
displaying a heat map on the displayed webpage.

18. The method of claim 1, wherein said graphically displaying an indication of the calculated link performance measure for the link in a content scheduler comprises:
displaying a content schedule timeline in the content scheduler; and
displaying a graphical indication of the calculated link performance measure overlaid on a module timeline in the content schedule timeline for a module during a time period that includes the link.

19. A data-assisted content programming system, comprising:
a link access data collector configured to collect link access data for a website;
a link performance measure generator configured to calculate a link performance measure for a link based on the link access data; and
a display engine configured to generate a graphical indication of the calculated link performance measure for the link for display by a content scheduler.

20. The system of claim 19, wherein the link access data collector comprises:
a link access tracker configured to at least track views of links on a webpage of the website and clicks of the links; and
a link data extractor configured to extract from the link access data view counts and click counts for views and clicks of the links that occurred during a specified time period for the links.

21. (canceled)

22. The system of claim 20, further comprising:
a web service that includes the link performance measure generator, wherein the web service is configured to receive a link performance measure request that includes a webpage identification, a date indication, a time indication, and a link identification for a link, wherein the web service is configured to access the database for information corresponding to the link performance measure request, and wherein the link performance measure is configured to calculate a link performance measure for the link using the accessed information.

23. The system of claim 19, wherein the link performance measure generator comprises:
a click through rate (CTR) calculator configured to calculate a click through rate for a link based on the link access data.

24. The system of claim 19, wherein the link performance measure generator comprises:
a user engagement information calculator configured to calculate a user engagement measure for a link based on the link access data.

25. The system of claim 19, wherein the link performance measure generator comprises:
a link revenue calculator configured to calculate a link revenue measure for a link based on the link access data.

26. The system of claim 22, wherein the display engine is configured to transmit the link performance measure request to the web service, and to receive the calculated link performance measure from the web service.

27. The system of claim 19, wherein the content scheduler is configured to display a webpage that includes the link with the graphical indication overlaid on the link.

28. The system of claim 19, wherein the display engine is configured to display a content schedule timeline with the graphical indication of the link performance measure overlaid on a timeline in the content schedule timeline for a module that includes the link.

29. A computer program product comprising a computer usable medium having computer readable program code means embodied in said medium for data-assisted content programming, comprising:
a first computer readable program code means for enabling a processor to collect link access data for a website;
a second computer readable program code means for enabling a processor to calculate a link performance measure for a link based on the link access data; and
a third computer readable program code means for enabling a processor to graphically display an indication of the calculated link performance measure for the link in a content scheduler.
